(19) United States
(12) Patent Application Publication
(10) Pub. No.: US 2005/0184687 A1
(43) Pub. Date: Aug. 25, 2005

(54) Apparatus and method for controlling operation of compressor

(75) Inventors: Eon Pyo Hong, Seoul (KR); Kyeong Bae Park, Seoul (KR); Ki Chul Choi, Seoul (KR); Sung Hyun Ki, Bucheon (KR); Tae Hee Kwak, Incheon (KR); Jong Tae Heo, Bucheon (KR); Yong Su Kim, Seoul (KR)

Correspondence Address: GREENBLUM & BERNSTEIN, P.L.C., 1950 ROLAND CLARKE PLACE, RESTON, VA, 20191, US

(73) Assignee: LG Electronics Inc., Seoul (KR)

(21) Appl. No.: 10/896,278

(22) Filed: Jul. 22, 2004

(30) Foreign Application Priority Data
Feb. 20, 2004 (KR) 11490/2004

(51) Int. Cl. H02P 7/08

(52) U.S. Cl. 318/66

(57) ABSTRACT

An apparatus and a method for controlling an operation of a compressor capable of preventing an under stroke or an overstroke of a compressor, occurring due to a variation value of a power voltage applied to a motor of the compressor includes a control unit outputting a selection signal according to a variation value of a power voltage applied to the motor of the compressor; capacitors connected to the motor; and a switching unit selectively varying capacitance of the capacitors based on the selection signal.

### BACKGROUND OF THE INVENTION

1. Field of the Invention

The present invention relates to a reciprocating compressor, and particularly, to an apparatus and method for controlling an operation of a reciprocating compressor installed in a refrigerator,

2. Description of the Prior Art

In general, by eliminating the use of a crankshaft for converting a rotary motion into a reciprocating motion, a reciprocating motor compressor has a low frictional loss, and accordingly the reciprocating motor compressor is superior to a general compressor in the compressing efficiency aspect.

When the reciprocating compressor is used for a refrigerator or an air conditioner, a stroke of the compressor may be constantly maintained by selecting a winding coil of a motor of the reciprocating compressor according to a variation value of a power voltage inputted to the reciprocating compressor and applying power to the selected winding coil. The reciprocating compressor in accordance with the conventional art will now be described with reference to FIG. 1.

FIG. 1 is a block diagram showing a structure of an apparatus for controlling an operation of a reciprocating compressor installed in a refrigerator.

As shown therein, the apparatus for controlling an operation of a reciprocating compressor includes a control unit (not shown) detecting a temperature in a refrigerator, applying power to a motor of the compressor based on the detected temperature, and outputting a control signal according to a value of a voltage applied to the motor; a switching unit 11 selecting one of a high mode, a normal mode and a low mode according to a control signal of the control unit; a PTC thermistor 12 electrically connected to the motor and cutting off an overcurrent generated when the reciprocating compressor is activated at an early stage to prevent the reciprocating compressor from being damaged; a reactor 13 connected to the PTC thermistor 12 in series; and a capacitor (C1) electrically connected to the PTC thermistor 12 and the reactor in parallel. The capacitor (C1) countervails inductance of a coil wound in the motor. That is, since the inductance of the coil is countervailed by the capacitor (C1), a sufficient stroke is generated even with a low input voltage. Here, the stroke means a distance that a piston of the reciprocating compressor moves while reciprocating.

Hereinafter, an operation of an apparatus for controlling an operation of the reciprocating compressor installed in a refrigerator will now be described.

First, the control unit (not shown) detects a temperature in the refrigerator, and cuts off power applied to a motor of the compressor by turning off a main relay (not shown) of the refrigerator in order to cut off cool air supplied into the refrigerator when the detected temperature in the refrigerator is lower than a temperature set by the user.

On the contrary, when a temperature in the refrigerator is higher than a temperature set by the user, the control unit applies power to the motor of the compressor by turning on the main relay (not shown) of the refrigerator in order to supply cool air into the refrigerator. Here, the control unit controls the relay according to a variation value of a power voltage (Vac) applied to the motor of the compressor to change a voltage mode (operation mode) of the motor.

For example, when a power voltage (Vac) supplied to the reciprocating compressor is the same as a reference voltage (e.g., 220 Volt), the control unit outputs a control signal for converting a voltage mode of the motor installed in the reciprocating compressor into a normal mode. When the power voltage supplied to the reciprocating compressor exceeds the reference voltage (e.g., over 220 Volt), the control unit outputs a control signal for converting a voltage mode of the motor installed in -the reciprocating compressor into a high mode. When a voltage supplied to the reciprocating compressor is below the reference voltage (e.g., below 220 Volt), the control unit outputs a control signal for converting a voltage mode of the motor installed in the reciprocating compressor 13 into a low mode. Here, the voltage mode is an operation mode for protecting a motor from an overvoltage and for stably driving the motor. That is, the voltage mode is a mode for selecting one of motor stator coils divided into a first coil (L1) (high mode), a second coil (L2) (standard mode) and a third coil (L3) (low mode).

Thereafter, the switching unit 11 selects one of a high mode, a normal mode and a low mode of the motor according to the control signal of the control unit.

In order to prevent the reciprocating compressor from being damayed by an overcurrent when power is supplied to the motor of the compressor at an early stage, the PTC thermistor 12 cuts off an overcurrent applied to the motor of the compressor when the compressor is activated at the early stage, thereby protecting the compressor from an overload. Here, the overcurrent means a current exceeding a reference current value allowed by the motor of the compressor. In addition, when self-resistance of the PTC thermistor 12 is increased by a current applied to the motor of the compressor, the PTC thermistor 12 is turned off, and at this time, the current is applied to the motor only through the capacitor (C1).

Hereinafter, a stroke range of the compressor when the current is applied to the motor only through the capacitor (C1) will now be described with reference to FIG. 2.

FIG. 2 is a view showing a compressor stroke range when the current is applied to the motor only through the capacitor (C1).

As shown in FIG. 2, when the current is applied to the motor through one capacitor (C1) regardless of a voltage mode of the motor (high mode, normal mode, low mode), each inductance (L1, L2, L3) according to the voltage mode and the capacitor (C1) have correlativity, thereby occurring a change of a stroke by a change of a load due to a change of a temperature around a refrigerator. For example, when the voltage mode is a high mode, a temperature around a refrigerator is low (when a cooling load is low), an overstroke occurs by the correlativity of L1 and C1. Here, the overstroke means that a piston and a discharge valve of a compressor collide against each other. By the collision, the reciprocating compressor is damaged, and a noise of the reciprocating compressor is increased.

On the contrary, when the current is applied to the motor through the capacitor (C1) regardless of a voltage mode of the motor (high mode, normal mode, low mode), if the voltage mode is a high mode, and a temperature around the refrigerator is high (if a cooling load is high), an under stroke occurs by the correlativity of L1 and C1. Here, the under stroke is less than a desired stroke of the reciprocating compressor.

As so far described, the apparatus for controlling an operation of the reciprocating compressor in accordance with the conventional art is disadvantageous in that an overstroke or an under stroke occurs according to a temperature around the refrigerator when a voltage mode of a motor installed in a compressor of a refrigerator is a high mode (L1).

A reciprocating compressor in accordance with a different conventional art is disclosed in U.S. Pat. No. 6,644,943 issued in Nov. 11, 2003.

### SUMMARY OF THE INVENTION

Therefore, an object of the present invention is to provide an apparatus and a method for controlling an operation of a compressor capable of preventing an under stroke or an overstroke of a compressor by varying capacitance of capacitors connected to the motor according to a variation value of a power voltage applied to a motor of a compressor.

To achieve these and other advantages and in accordance with the purpose of the present invention, as embodied and broadly described herein, there is provided an apparatus for controlling an operation of a reciprocating comprising: a control unit outputting a selection signal according to a variation value of a power voltage applied to a motor of a compressor; capacitors connected to the motor; and a switching unit selectively varying capacitance of the capacitors based on the selection signal.

To achieve these and other advantages and in accordance with the purpose of the present invention, as embodied and broadly described herein, there is provided an apparatus for controlling an operation of a compressor comprising: a control unit outputting a selection signal according to a variation value of a power voltage applied to a motor of a compressor installed in a refrigerator; a first capacitor connected to the motor in series; a second capacitor; and a switching unit selectively connecting the second capacitor to the first capacitor in parallel based on the selection signal.

To achieve these and other advantages and in accordance with the purpose of the present invention, as embodied and broadly described herein, there is provided a method for controlling an operation of a compressor comprising: outputting a selection signal according to a variation value of a power voltage applied to a motor of a compressor; and selectively varying capacitance of capacitors connected to the motor based on the selection signal.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a unit of this specification, illustrate embodiments of the invention and together with the description serve to explain the principles of the invention.

In the drawings:

FIG. 1 is a block diagram showing a structure of an apparatus for controlling an operation of a reciprocating compressor installed in a refrigerator;

FIG. 2 is a view showing a stroke range of a compressor when a current is applied to a motor only through a capacitor (C1);

FIG. 3 is a block diagram showing a structure of an apparatus for controlling an operation of a reciprocating compressor installed in a refrigerator in accordance with the present invention;

FIG. 4 is an operation flow chart of a method for controlling an operation of a reciprocating compressor installed in a refrigerator in accordance with the present invention; and

FIG. 5 is a view showing a stroke range of a compressor when a current is applied to a motor through a first capacitor (C1) and a second capacitor (C2).

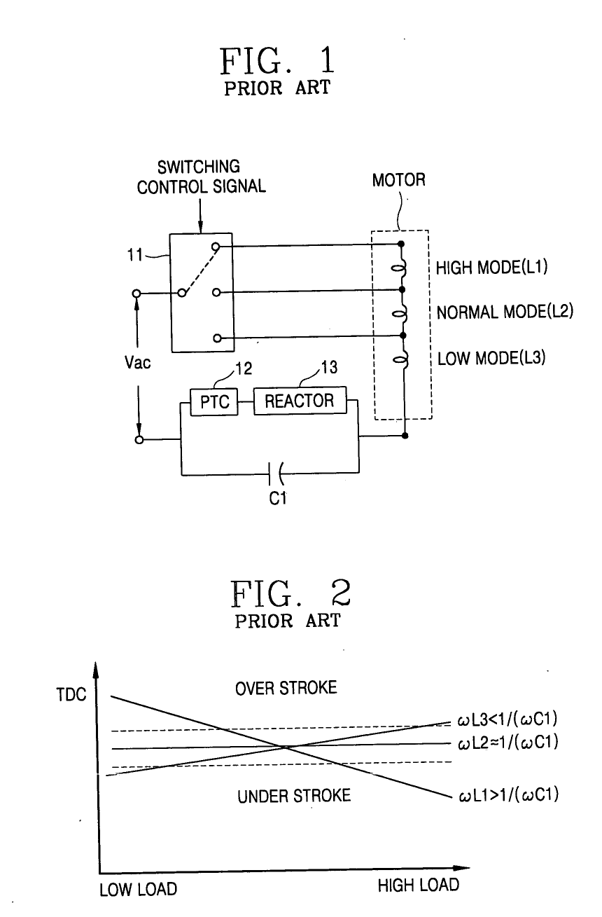

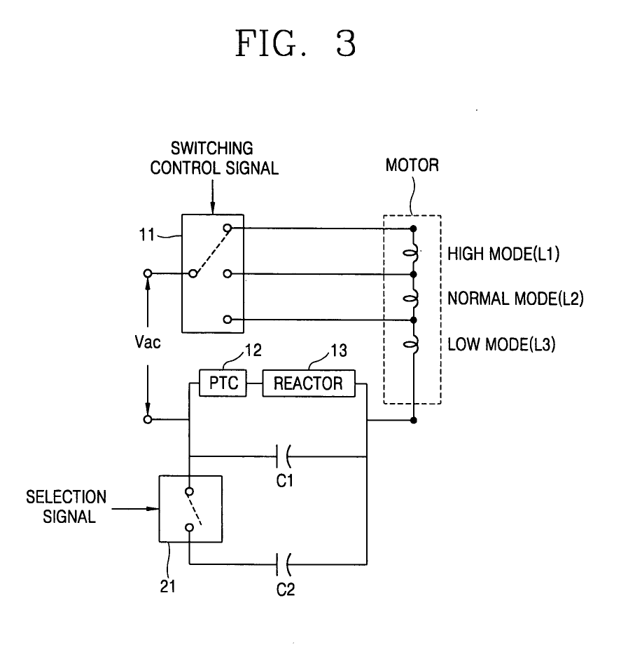

### DETAILED DESCRIPTION OF THE PREFERRED EMBODIMENTS

A preferred embodiment of an apparatus and a method for-controlling an operation of a compressor capable of preventing an under stroke or an overstroke of a compressor by varying capacitance of capacitors connected to a motor according to a variation value of a power voltage applied to the motor of a compressor in a refrigerator will now be described in detail with reference to FIGS. 3˜5.

FIG. 3 is a block diagram showing a structure of an apparatus for controlling an operation of a reciprocating compressor installed in a refrigerator in accordance with the present invention.

As shown therein, an apparatus for controlling an operation of a reciprocating compressor in accordance with the present invention includes: a first capacitor (C1) electrically connected to a motor of the reciprocating compressor, and operating the motor of the compressor with inductance of the coil wound in the motor countervailed; a second capacitor (C2) selectively connected to the first capacitor (C1) in parallel, and operating the motor of the compressor with inductance of the coil wound in the motor countervailed; a control unit (not shown) outputting a switching control signal for varying a voltage mode of the motor according to a variation value of a power voltage (Vac) applied to the motor and outputting a selection signal for selecting the first capacitor or both first capacitor and second capacitor; a first switching unit 11 varying a voltage mode of the motor based on a switching control signal of the control unit; a second switching unit 21 connecting the second capacitor to the first capacitor (C1) in parallel based on the selection signal and varying capacitance; a PTC thermistor (Positive Temperature coefficient Thermistor) 12 connected to the first capacitor (C1) and the second capacitor (C2) in parallel and cutting off an overcurrent generated when power is applied to the motor at an early stage; and a reactor 13 connected to the PTC thermistor 12 in series and cutting off a surge current generated when power is applied to the motor at an early stage. Here, the reactor 13 is not an essential component and may be installed in order to cut off a surge current generated when power is applied to the motor at an early stage or may not be installed. Here, the overcurrent means a current exceeding a reference current value allowed by a motor of the reciprocating compressor, and the surge current means a maximum current of the current exceeding the reference current value allowed by the motor. In addition, operation descriptions about the reactor and the PTC thermistor 12 that are the same as the conventional art will be omitted.

Hereinafter, an operation of the apparatus for controlling an operation of a reciprocating compressor installed in a refrigerator will now be described in detail.

First, the control unit detects a temperature in the refrigerator, and if the detected temperature in the refrigerator is lower than a temperature set by a user, the control unit turns off a main relay (not shown) of the refrigerator in order to cut off cool air supplied into the refrigerator to thereby cut off power applied to the motor of the compressor.

On the contrary, if the temperature in the refrigerator is higher than a temperature set by the user, the control unit turns on the main relay (not shown) of the refrigerator in order to supply cool air into the refrigerator to thereby apply power to the motor of the compressor. Here, the control unit controls the first switching unit 11 according to a variation value of a power voltage (Vac) applied to the motor of the compressor to thereby control a voltage mode (operation mode) of the compressor.

For example, when the power voltage (Vac) supplied to the motor of the reciprocating compressor is the same as a reference value (e.g., 220 Volt), the control unit outputs a switching control signal for converting a voltage mode of the motor installed in the reciprocating compressor into a normal mode. When a power voltage supplied to the motor of the reciprocating compressor exceeds a reference voltage (e.g., over 220 Volt), the control unit outputs a switching control signal for converting a voltage mode of the motor installed in the reciprocating compressor into a high mode. When the power voltage supplied to the motor of the reciprocating compressor is below a reference voltage (e.g., below 22 volts), the control unit outputs a switching control signal for converting a voltage mode of the motor installed in the reciprocating compressor into a low mode. Here, the voltage mode is a mode for protecting the motor from an overvoltage and for stably driving the motor. That is, the voltage mode is a mode for selecting one of motor stator coils divided into a first coil (L1) (high mode), a second coil (normal mode) and a third coil (L3) (low mode) according to an input voltage.

Accordingly, the control unit generates a switching control signal for converting a voltage mode of the motor installed in the reciprocating compressor according to a variation value of the power voltage supplied to the motor of the reciprocating compressor and outputs the generated switching control signal to the first switching unit 11.

The first switching unit 11 switches a voltage mode of the motor into one of a high mode, a normal mode and a low mode according to the switching control signal of the control unit.

Thereafter, when the voltage mode of the motor is a normal mode or a low mode, the control unit controls the second switching unit 21 to open the second capacitor (C2) connected to the first capacitor (C1) in parallel. And when the voltage mode is a high mode, the control unit outputs a selection signal for connecting the first capacitor (C1) and the second capacitor (C2) in parallel to the second switching unit 21.

The second switching unit 21 switches the second capacitor based on the selection signal. That is, if the selection signal is received, the second switching unit 21 connects the first capacitor (C1) and the second capacitor (C3) in parallel. But if the selection signal is not received, the second capacitor (C2) connected to the first capacitor (C1) in parallel is opened to thereby vary capacitance.

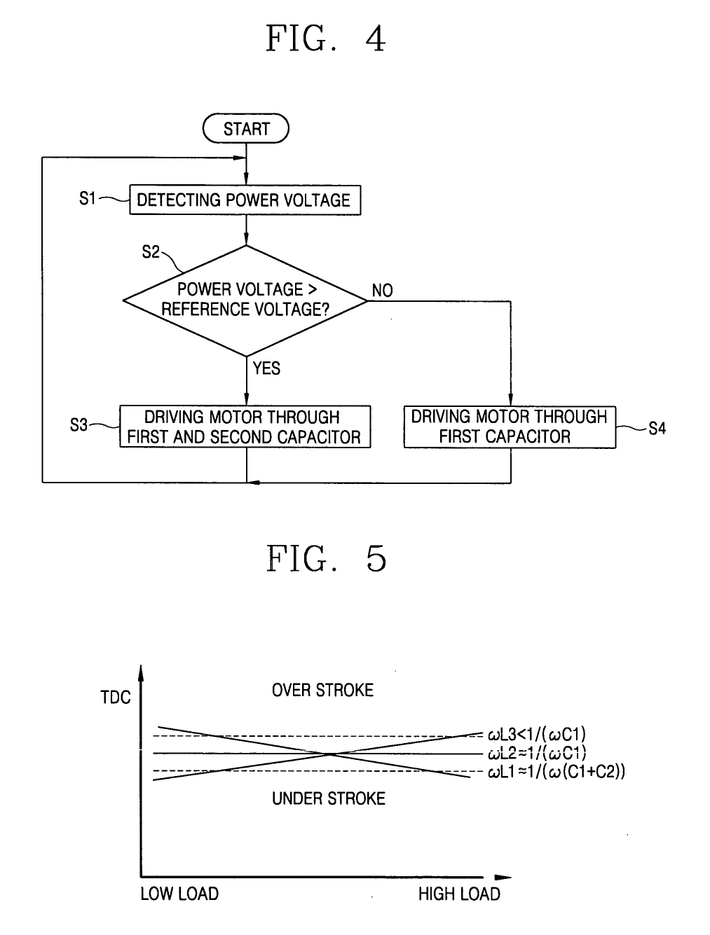

Hereinafter, a method for controlling the first capacitor (C1) and the second capacitor (C2) will now be described in detail with reference to FIG. 4.

FIG. 4 is an operation flow chart for a method for controlling an operation of a reciprocating compressor installed in the refrigerator in accordance with the present invention.

As shown therein, the method for controlling an operation of the reciprocating compressor installed in the refrigerator includes: detecting a power voltage applied a motor of the compressor and comparing the detected power voltage to a preset reference value; and operating the motor of the compressor through the first capacitor (C10 when the power voltage is smaller than the preset reference voltage and operating the motor of the compressor through the first capacitor (C1) and the second capacitor (C2) when the power voltage is larger than the preset reference voltage.

First, the control unit detects a power voltage to be applied to the motor of the compressor and compares the detected power voltage and the preset reference voltage (S1).

When the power voltage is larger than the preset reference voltage, the control unit outputs a selection signal for connecting the first capacitor (C1) and the second capacitor (C2) in parallel to the second switching unit 21. Here, The second switching unit 21 connects the second capacitor (C20) to the first capacitor (C1) based on the selection signal. Here, a current is applied to the motor through the first capacitor (C1) and the second capacitor (C2) connected in parallel (S2, S3).

On the contrary, when the power voltage is smaller than the preset reference voltage, the control unit opens the second capacitor (C2) connected to the first capacitor (C1) in parallel so that the current is applied to the motor only through the first capacitor (C1) (S2, S4).

Accordingly, in the present invention, when a compressor stroke is changed by a change of a cooling load due to a change of a temperature around the refrigerator, that is, when the cooling load is low (when the temperature around the refrigerator is low) or when the cooling load is high (when the temperature around the refrigerator is high), capacitance of capacitors connected to the motor is varied according to a variation value of a power voltage applied to the motor, so that an under stroke or an overstroke is remarkably reduced as shown in FIG. 5.

Hereinafter, a stroke range of a compressor piston when the current is applied to the motor only through the first capacitor and a stroke range of the compressor piston when the current is applied to the motor through the first capacitor (C1) and the second capacitor (C2) will now be described with reference to a graph of FIG. 5 showing that the under stroke or the overstroke is remarkably reduced.

FIG. 5 is a view showing a stroke region of a compressor piston when the current is applied to the motor through the first capacitor (C1) and the second capacitor (C2).

As shown in FIG. 5, when the current is applied to the motor through one capacitor (C1) or two capacitors (C1, C2) according to a voltage mode of the motor (high mode, normal mode, low mode), an overstroke or the under stroke is remarkably reduced by following expression 2 when the voltage mode is the high mode, the normal mode or the low mode.
ω L1>1/(ω(C1+C2)), ω L2>1/(ω C1, ω L3>1/(ω C1) expression 1

Here, ω is an angular frequency, L1, L2 and L3 are inductance of the motor, and C1 and C2 are capacitance.

For example, when the voltage mode is a high mode, and a cooling load is low, an overstroke is remarkably reduced by correlativity of L1 and C1+C2. Here, the overstroke means that a piston of a compressor and a discharge valve collide against each other.

In addition, when the voltage mode is a high mode and a cooling load is high, the under stroke is remarkably decreased by the correlativity of L1 and C1+C2. Here, the under stroke is below a desired stroke of the reciprocating compressor.

As so far described, the present invention has an effect in that an under stroke or an overstroke of the compressor is prevented regardless of a cooling load by varying capacitance of capacitors connected to a motor, according to a variation value of a power voltage applied to the motor.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

1. An apparatus for controlling an operation of a reciprocating comprising:
a control unit outputting a selection signal according to a variation value of a power voltage applied to a motor of a compressor;
capacitors connected to the motor; and
a switching unit selectively varying capacitance of the capacitors based on the selection signal.

2. The apparatus of claim 1, wherein the control unit outputs the selection signal when a power voltage exceeds a reference voltage applied to the motor of the compressor.

3. The apparatus of claim 1, wherein the capacitors connected to the motor includes a first capacitor and a second capacitor, wherein the first capacitor is connected to the motor in series, and the second capacitor is selectively connected to the first capacitor in parallel.

4. The apparatus of claim 3, wherein the switching unit connects the second capacitor to the first capacitor in parallel when the selection signal is received.

5. The apparatus of claim 4, wherein the switching unit opens the second capacitor connected to the first capacitor in parallel when a power voltage applied to the motor of the compressor is the reference voltage or less.

6. An apparatus for controlling an operation of a compressor comprising:
a control unit outputting a selection signal according to a variation value of a power voltage applied to a motor of a compressor installed in a refrigerator;
a first capacitor connected to the motor in series;
a second capacitor; and
a switching unit selectively connecting the second capacitor to the first capacitor in parallel based on the selection signal.

7. The apparatus of claim 6, wherein the control unit outputs the selection signal when the power voltage exceeds a preset reference voltage.

8. The apparatus of claim 7, wherein the switching unit opens the second capacitor connected to the first capacitor in parallel when a power voltage applied to the motor of the compressor is the preset reference voltage or less.

9. A method for controlling an operation of a compressor comprising:
outputting a selection signal according to a variation value of a power voltage applied to a motor of a compressor; and
selectively varying capacitance of capacitors connected to the motor based on the selection signal.

10. The method of claim 9, wherein the capacitors are connected to each other in parallel.

11. The method of claim 9, wherein the capacitors are connected to each other in parallel when the power voltage exceeds a reference voltage.

12. An apparatus for controlling an operation of a compressor comprising a switching unit selectively switching capacitors connected to the motor according to a variation value of a power voltage applied to a motor of a compressor.
